(19) United States
(12) Patent Application Publication
(10) Pub. No.: US 2019/0274191 A1
(43) Pub. Date: Sep. 5, 2019

(54) DOMESTIC APPLIANCE

(71) Applicant: BSH Hausgeräte GmbH, Munich (DE)

(72) Inventors: José Miguel Burdio Pinilla, Zaragoza (ES); Tomas Cabeza Gozalo, Zaragoza (ES); Sergio Llorente Gil, Zaragoza (ES); Oscar Lucia Gil, Zaragoza (ES); Ignacio Millan Serrano, Zaragoza (ES); Alejandro Naval Pallares, Barbastro, Huesca (ES); Hector Sarnago Andia, Olvega (Soria) (ES)

(21) Appl. No.: 16/334,032

(22) PCT Filed: Dec. 12, 2017
(86) PCT No.: PCT/IB2017/057815

§ 371 Date: Mar. 18, 2019

(30) Foreign Application Priority Data
Dec. 19, 2016 (ES) P201631614

(51) Int. Cl. H05B 6/06; H05B 6/12; H05B 6/44

(52) U.S. Cl. CPC H05B 6/065; H05B 6/1209; H05B 2213/05; H05B 2213/03; H05B 6/44

(57) ABSTRACT

A household appliance device includes an integer number N of row switching elements at a row position i, wherein i is an integer number 1≤i≤N, an integer number M of column switching elements at a column position j, wherein j is an integer number 1≤j≤M, and a heating matrix including at least N×M heating matrix elements having positions (i, j), with N+M>2, wherein a heating matrix element at the position (i,j) includes at least one inductor at the position (i,j) and is connected to both the i-th row switching element and the j-th column switching element.

The invention relates to a household appliance device, in particular a cooking appliance device as set out in the preamble of claim 1.

A household appliance device with at least one inverter unit with a half bridge circuit or full bridge circuit design for operating multiple inductors by means of a multiplexer is already known from the prior art.

It is the object of the invention in particular to provide a generic device with improved properties in respect of efficiency. According to the invention the object is achieved by the features of claim 1, while advantageous configurations and developments of the invention will emerge from the subclaims.

A household appliance device, in particular a cooking appliance device and preferably a cooktop device, is proposed, with at least a number N of row switching elements, with at least a number M of column switching elements and with at least one heating matrix, which has at least one, in particular just one, number N×M of heating matrix elements, wherein, for any i from 1 to N and any j from 1 to M with a total number N+M of column switching elements and row switching elements greater than 2, the heating matrix element at position i,j comprises at least one, preferably just one, inductor at position i,j and is connected to both the i-th row switching element and the j-th column switching element.

A “household appliance device” in this context refers in particular to at least one part, preferably at least one sub-assembly, of a household appliance. The household appliance device can in particular also comprise the entire household appliance. The household appliance is configured in particular as a cooking appliance, preferably a microwave, an oven and/or an, in particular variable, cooktop, in particular a matrix cooktop, and particularly preferably as an inductive cooking appliance, for example in particular an induction oven and/or preferably an induction cooktop, in particular a matrix induction cooktop. A “cooking appliance device” refers in particular to a household appliance device, which at least partially forms a cooking appliance. A “variable cooktop” in this context refers in particular to a cooktop, in which inductors are arranged, in particular in a regular spatial arrangement, in particular below a cooktop plate of the household appliance device and at least partially form at least one heating zone, preferably multiple variable heating zones, which comprise(s) a region of the cooktop plate preferably of at least 10%, more preferably at least 30% and particularly advantageously at least 40% of an overall area of the cooktop plate. In particular the inductors are provided to form the heating zone as a function of a position of a cookware item positioned on the cooktop plate and to tailor it to the cookware item. “Provided” in particular means specifically programmed, designed and/or equipped. That an object is provided for a specific function means in particular that the object fulfills and/or performs said specific function in at least one application and/or operating state. A “number” in this context means in particular any number from the set of natural numbers. It should always be the case in particular that the total number N+M of column switching elements and row switching elements is greater than 2, when the number N of row switching elements and/or the number M of column switching elements is greater than 1. A “row switching element” and/or a “column switching element” in this context refers in particular to switching elements which are assigned to rows and/or columns of a grid of a schematic circuit arrangement and/or define such. The schematic circuit arrangement is in particular different from a spatial arrangement, in which the column switching elements and row switching elements can be arranged in an in particular particularly compact arrangement as preferred by the person skilled in the art. The row switching elements are in particular connected to a reference potential that is common to the row switching elements. The reference potential common to the row switching elements is in particular an operating potential of an operating voltage, with which the household appliance device is operated. The reference potential common to the row switching elements here is in particular a ground potential. The column switching elements are in particular connected to a further reference potential that is common to the column switching elements. The further reference potential common to the column switching elements is in particular a further operating potential of the operating voltage. The further reference potential common to the column switching elements is in particular different from a ground potential. In particular an operating voltage is present between the reference potential common to the row switching elements and the further reference potential common to the column switching elements. A “switching element” in this context refers in particular to an element, which is provided to connect a first connection to at least one second connection in an electrically conducting manner in at least one first switching state and to disconnect the first connection from the second connection in at least one second switching state. The switching element in particular has at least one control connection, by way of which the switching state of the switching element can be controlled. The switching element is provided in particular to transition from one of the switching states to the other switching state respectively in a switching operation. The switching element here can be configured as any switching element, preferably a semiconductor switching element, that appears expedient to the person skilled in the art, for example as a transistor, preferably as a FET, MOSFET and/or IGBT, preferably as an RC-IGBT and particularly preferably as a HEMT transistor. A “HEMT transistor” refers in particular to a High Electron Mobility Transistor, in particular with a particularly high level of electron mobility, which in particular at 25° C. is in particular at least 400 cm² V⁻¹ s⁻¹, preferably at least 600 cm² V⁻¹ s⁻¹, more preferably at least 800 cm² V⁻¹ s⁻¹ and particularly preferably at least 1000 cm² V⁻¹ s⁻¹. HEMT transistors also refer in particular to Modulation Doped Field Effect Transistors (MODFET), Two Dimensional Electron Gas Field Effect Transistors (TEGFET), Selectively Doped Heterojunction Transistors (SDHT) and/or Heterojunction Field Effect Transistors (HFET). The switching element in particular has at least one first connection, which is preferably a source connection, a second connection, which is preferably a drain connection, and/or a control connection, which is in particular a gate connection. At least one diode, in particular a feedback diode, and/or at least one capacitance, in particular a damping capacitance, of the household appliance, can be connected parallel to the switching element. At least one i-th row switching element and at least one j-th column switching element, which are connected in particular in a full bridge topology or preferably a half bridge topology, serve in particular as inverter switching elements and together form at least partially, preferably completely, an inverter unit at position i,j of the household appliance device. The household appliance device comprises in particular a number N×M of inverter units. An “inverter unit at position i,j” refers in particular to a unit, which is provided to supply and/or generate a high-frequency heating current, preferably with a frequency of at least 1 kHz, in particular at least 10 kHz and advantageously at least 20 kHz, in particular to operate the inductor at position i,j. The household appliance device in particular has a control unit, which is provided to activate the row switching elements and the column switching elements. A “control unit” refers in particular to an electronic unit, which is preferably at least partially integrated in a control and/or regulation unit of a household appliance. The control unit preferably comprises a computation unit and in particular, in addition to the computation unit, a storage unit with a control and/or regulation program stored therein, which is provided to be run by the computation unit. The control unit is particularly advantageously provided to activate the row switching elements and the column switching elements as inverter switching elements, in particular such that a soft switching operation takes place between at least one first switching state and a second switching state of the switching elements. A “soft switching operation” refers in particular to a switching operation with a vanishingly small power loss, which takes place in particular when the switching operation is in particular at least essentially current-free and/or preferably at least essentially voltage-free. An “at least essentially current-free switching operation”, also known in particular as “zero current switching (ZCS)”, refers in particular to a soft switching operation, in which a current, which flows in particular immediately before a switching operation in the heating matrix element at position i,j and in particular in the inductor at position i,j, is at least essentially vanishingly low, in particular essentially zero. The control unit is provided in particular to switch the switching elements during an at least essentially current-free switching operation with a switching frequency, which is smaller than or equal to a resonant frequency of the heating matrix element at position i,j. An “at least essentially voltage-free switching operation”, also known as “zero voltage switching (ZVS)”, refers in particular to a soft switching operation, in which a voltage, which is present and/or drops in particular immediately before a switching operation at the heating matrix element at position i,j and in particular at the inductor at position i,j, is at least essentially vanishingly low, in particular essentially zero. The control unit is provided in particular to switch the switching elements during an at least essentially voltage-free switching operation with a switching frequency, which is greater than a resonant frequency of the heating matrix element at position i,j. A “vanishingly low value” refers in particular to a value which is in particular at least a factor 10, preferably at least a factor 50, more preferably at least a factor 100 and particularly preferably at least a factor 500 lower than an operating maximum value. A “heating matrix” refers in particular to a grid of a schematic circuit arrangement of heating matrix elements at position i,j. The heating matrix element at position i,j is in particular connected at least indirectly and preferably directly to both the i-th row switching element and the j-th column switching element. That “at least two electrical components are connected directly to one another” in this context means in particular that a connection between the electrical components is free of at least a further electrical component, which changes a phase between a current and a voltage and/or preferably a current and/or voltage itself. The inductor at position i,j particularly preferably has at least one, in particular just one, connection at position i,j, which is connected to both the i-th row switching element, in particular to a first connection of the i-th row switching element, and also the j-th column switching element, in particular a second connection of the j-th column switching element. An “inductor” refers in particular to an electrical component, which is provided in at least one cooking operating state at least partially to heat at least one cookware item positioned on the cooktop plate of the household appliance device inductively. The inductor comprises at least one wound electrical conductor, preferably in the form of a circular disk, through which a high-frequency heating current flows in the cooking operating state at least. The inductor is preferably provided to convert electrical energy to an alternating magnetic field in order to induce eddy currents and/or magnetic reversal effects, which are converted to heat, in the cookware item.

A corresponding configuration can advantageously provide a household appliance device with improved properties in respect of efficiency, in particular cost efficiency and/or energy efficiency. In particular the number of switching elements can be reduced, as some switching elements operate multiple inductors, thereby reducing component costs. Different inductors in the heating matrix can also advantageously be activated individually, thereby reducing energy consumption and in particular reducing any electrical scatter field. The arrangement cited above particularly advantageously allows the switching elements to be switched softly, in particular in an at least essentially current-free or an at least essentially voltage-free manner, thereby reducing switching losses. It also allows advantageous detection of cookware items, thereby removing the need for additional components, such as sensor elements for example.

In order to reduce the space required for the inductors and in particular to achieve an efficient spatial arrangement of inductors for a cooking operation with cookware items, it is further proposed that the inductors are arranged spatially in an inductor matrix which differs, in respect of the proximity relationship of at least two of the inductors relative to one another, from the heating matrix in which the inductors are arranged in a schematic circuit. An “inductor matrix” refers in particular to a grid of a spatial arrangement of the inductors below a cooktop plate of the household appliance device. A “different proximity relationship” means in particular that nearest neighbors of inductors at position i,j in the inductor matrix are not nearest neighbors of inductors at position i,j in the heating matrix.

In one preferred configuration of the invention it is proposed that in the inductor matrix the inductors are arranged spatially such that at least one inductor at position i,j, for which i=j in the heating matrix, is adjacent to at least one inductor at position i,j, for which i≠j in the heating matrix. An “inductor at position i,j, for which i=j in the heating matrix” refers in particular to a diagonal inductor arranged on a diagonal of the heating matrix. An “inductor at position i,j for which i≠j in the heating matrix” refers in particular to an off-diagonal inductor, which is arranged away from a diagonal of the heating matrix. Preferably arranged between at least two inductors at position i,j, for which i=j in the heating matrix, is at least one inductor at position i,j, for which i≠j in the heating matrix. An inductor at position i,j, for which i=j in the heating matrix, is particularly preferably surrounded, preferably surrounded in a circular manner, by multiple, in particular at least three, preferably at least four and particularly preferably at least five inductors at position i,j, for which i≠j in the heating matrix. Alternatively it is conceivable for the heating matrix to be free of heating matrix elements at position i,j and in particular inductors at position i,j, for which i=j in the heating matrix. This further simplifies activation of the household appliance device, as simultaneous operation of diagonal inductors in particular can be avoided.

In one particularly preferred configuration of the invention it is proposed that in the inductor matrix inductors at position i,j of identical i or identical j are adjacent and preferably directly adjacent to one another. In particular the inductors at position i,j of identical i or identical j are arranged in the same row or column of the heating matrix. In particular the inductors at position i,j of identical i or j are arranged grouped together and form in particular at least partially, preferably at least largely and particularly preferably completely at least one heating zone for a cookware item. More preferably inductors at position i,j of different i or j at least partially form different heating zones. This further simplifies activation of the household appliance device, as simultaneous operation of at least two inductors at position i,j, for which i=j in the heating matrix, can be particularly advantageously avoided.

It is conceivable for the total number N+M of column switching elements and row switching elements to be smaller than or equal to the number N×M of heating matrix elements. In order to operate a number N×M of heating matrix elements with the smallest possible total number N+M of column switching elements and row switching elements and advantageously to reduce component costs, it is proposed that the number N of column switching elements is equal to the number M of row switching elements. In particular the heating matrix is then configured as a quadratic matrix.

In order to exclude unwanted activation of at least two diagonal inductors, it is proposed that the total number N+M of column switching elements and row switching elements is one greater than the number N×M of heating matrix elements. The heating matrix is then configured in particular as a vector, preferably a row vector, in particular when the number N of row switching elements is equal to 1 or as a column vector, in particular when the number M of column switching elements is equal to 1.

It is also proposed that the heating matrix element at position i,j has at least one diode at position i,j, by means of which the inductor at position i,j is connected at least to the i-th row switching element. In particular the diode at position i,j is connected to the connection at position i,j between the inductor at position i,j and the i-th row switching element. The inductor at position i,j in particular allows a current flow in the direction of the i-th row switching element and preferably blocks a current flow in the direction of the inductor at position i,j. The diode at position i,j can be dispensed with, particularly when the number of row switching elements is equal to 1. Also a backflow diode and/or a damping capacitor of the household appliance device in particular could be connected parallel to the j-th column switching element. Also advantageously the heating matrix element at position i,j has at least one further diode at position i,j, by means of which the inductor at position i,j is connected at least to the j-th column switching element. In particular the further diode at position i,j is connected to the connection at position i,j between the inductor at position i,j and the j-th column switching element. The diode at position i,j in particular allows a current flow in the direction of the inductor at position i,j and preferably blocks a current flow in the direction of the j-th column switching element. Also the further diode at position i,j can be dispensed with, when the number M of column switching elements is equal to 1. Also a backflow diode and/or a damping capacitor in particular could be connected parallel to the i-th row switching element. This in particular prevents an uncontrolled current flow in particular between multiple heating matrix elements.

It is further proposed that the heating matrix element at position i,j has at least one capacitance at position i,j, by means of which the inductor at position i,j is connected at least to at least one reference potential common to the heating matrix elements. The reference potential common to the heating matrix elements is in particular the operating potential. The heating matrix element at position i,j also has in particular at least one further capacitance at position i,j, by means of which the inductor at position i,j is connected at least to at least one further reference potential common to the heating matrix elements. The further reference potential common to the heating matrix elements is in particular the further operating potential. The capacitance at position i,j comprises at least one capacitor. The capacitance can preferably comprise multiple capacitors, in particular a capacitor network, which is preferably made up of at least some capacitors connected in series and/or some connected in a parallel manner. The capacitance can also be settable in particular. The inductor at position i,j has in particular at least one further connection at position i,j, which is connected to both the capacitance at position i,j and the further capacitance at position i,j. This advantageously allows a natural frequency of an oscillating circuit of the household appliance device to be matched to the field of application by selecting the capacitances correspondingly.

It is further proposed that the heating matrix comprises a number N of row diodes, the i-th row diode connecting at least the i-th row switching element to at least one further reference potential common to the row switching elements, in particular the further operating potential. It is further proposed that the heating matrix comprises a number M of column diodes, the j-th column diode connecting at least the j-th column switching element to at least one reference potential common to the column switching elements, in particular the operating potential. This allows a particularly soft switching operation to be achieved.

It is further proposed that in at least one cookware detection mode, when an operating voltage has an at least essentially vanishingly low value, the control unit is provided to determine at least one electrical characteristic variable occurring at at least one of the inductors. The electrical characteristic variable is preferably correlated with an electromagnetic coupling of the inductor to a cookware item, in particular with a degree of cover and/or a material of the cookware item. In particular the control unit can deduce and preferably determine the electromagnetic coupling of the inductor to the cookware item at least from the electrical characteristic variable. The electrical characteristic variable corresponds in particular to a direct control variable. The electrical characteristic variable is advantageously an electrical signal and/or electronic signal, in particular one measured by a sensor unit of the household appliance device. The electrical characteristic variable is preferably a frequency, amplitude and/or phase of a voltage present at the inductor and/or of a current flowing through the inductor. This improves the flexibility of the household appliance device, as cookware items can be detected.

It is further proposed that in cookware detection mode the control unit is provided first to charge the inductor and then, when an operating voltage has an at least essentially vanishingly low value, to discharge it again. In cookware detection mode the control unit is advantageously provided to acquire a characteristic line of a discharging operation of the inductor and to use this characteristic line to determine the electrical characteristic variable. The characteristic line is in particular a time profile of the electrical characteristic variable. In particular the control unit is provided to determine the electrical characteristic value by tailoring a comparative characteristic line to the characteristic line, in particular based on parameters for generating the comparative characteristic line. This allows easy discharging of the inductor, avoiding short circuits with further electrical components.

The household appliance device here should in particular not be limited to the application and embodiment described above. In particular the household appliance device can have a different number of individual elements, components and units from the number cited herein to achieve a mode of operation described herein. In respect of the value ranges cited in this disclosure, values within the cited limits should also preferably be deemed to be disclosed and applicable in any manner.

Further advantages will emerge from the description of the drawing that follows. The drawing shows a number of exemplary embodiments of the invention. The drawing, description and claims container numerous features in combination. The person skilled in the art will also expediently consider the features individually and combine them in useful further combinations.

### IN THE DRAWING

FIG. 1 shows a schematic view from above of a household appliance with a household appliance device,

FIG. 2 shows a schematic circuit diagram of a part of the household appliance device with a heating matrix,

FIG. 3 shows a schematic view from above of a part of the household appliance device with an inductor matrix,

FIG. 4 shows a schematic flow chart of a method for operating a household appliance device with a cookware detection mode,

FIGS. 5a-b show different diagrams of typical current and/or voltage profiles during operation of the household appliance device,

FIGS. 6a, b show different diagrams of typical current and/or voltage profiles during operation of the household appliance device,

FIG. 7 shows a circuit diagram of a further household appliance device,

FIG. 8 shows a circuit diagram of a further household appliance device,

FIG. 9 shows a circuit diagram of a further household appliance device,

FIG. 10 shows a circuit diagram of a further household appliance device,

FIG. 11 shows a circuit diagram of a further household appliance device,

FIG. 12 shows a circuit diagram of a further household appliance device,

FIG. 13 shows a circuit diagram of a further household appliance device,

FIG. 14 shows a circuit diagram of a further household appliance device,

FIG. 15 shows a circuit diagram of a further household appliance device and

FIG. 16 shows a circuit diagram of a further household appliance device.

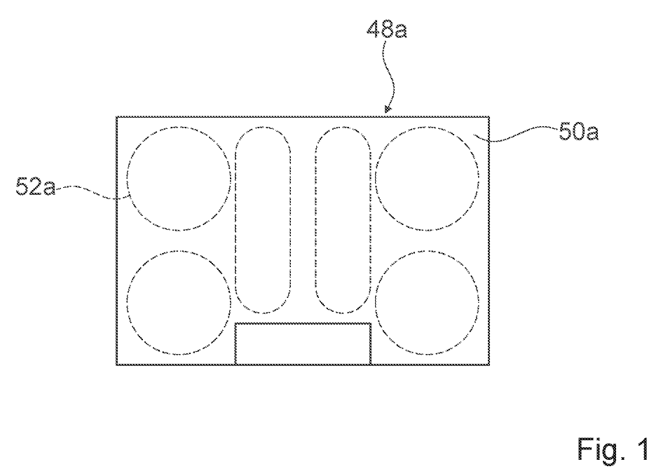

FIG. 1 shows a schematic view from above of a household appliance 48a with a household appliance device. In the present instance the household appliance 48a is configured as a cooking appliance. The household appliance 48a is a cooktop, in particular a variable induction cooktop. Alternatively the household appliance 48a can be configured as any household appliance 48a, in particular a cooking appliance, that is different from a cooktop, and in particular appears advantageous to the person skilled in the art, for example a microwave or induction oven.

The household appliance device has a cooktop plate 50a. The household appliance device is provided to operate at least one cookware item, which is arranged in any position on the cooktop plate 50a. The cooktop plate 50a comprises preferred heating zone positions 52a, which characterize preferred positions for cookware items. In the present instance the cooktop plate 50a has six preferred heating zone positions 52a. Only one of the preferred heating zone positions 52a is shown with a reference character for greater clarity. The cooktop plate 50a can in particular have any number of preferred heating zone positions 52a or no preferred heating zone positions 52a.

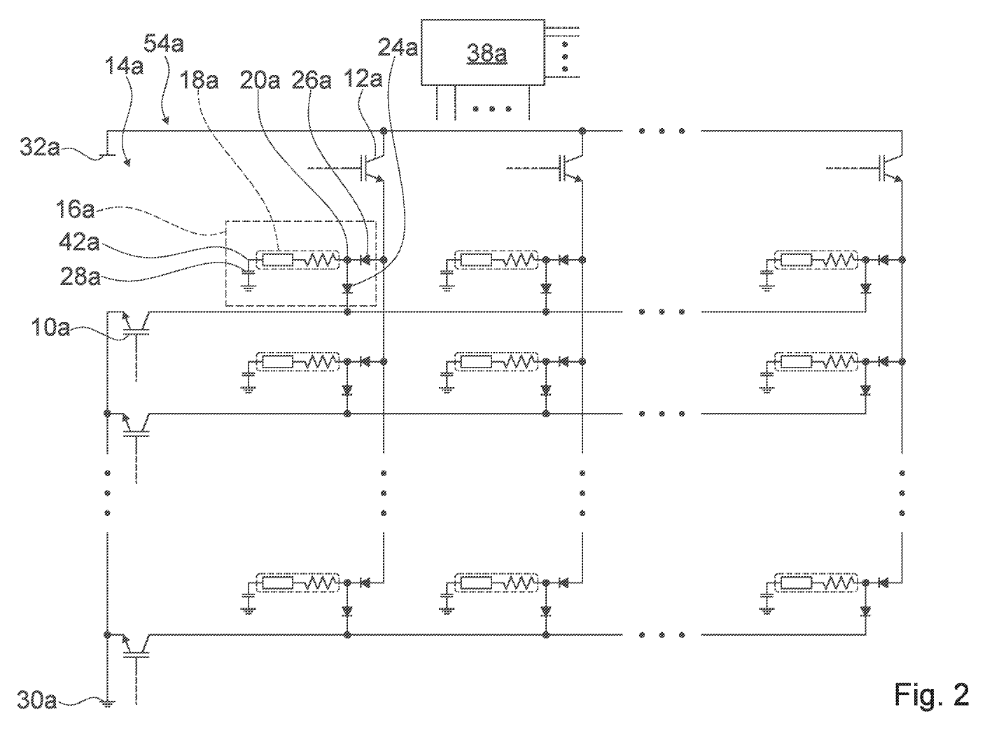

FIG. 2 shows a schematic circuit diagram of a part of the household appliance device. The household appliance device comprises at least a number N of row switching elements 10a. The household appliance device also comprises at least a number M of column circuit elements 12a. The household appliance device comprises at least one heating matrix 14a. The heating matrix 14a has at least one heating matrix element 16a at position i,j for any i from 1 to N and any j from 1 to M. The heating matrix 14a has a number N×M of heating matrix elements 16a. A total number N+M of row switching elements 10a and column switching elements 12a is greater than 2. The total number N+M of row switching elements 10a and column switching elements 12a is smaller than or equal to the number N×M of heating matrix elements 16a. In the present instance the household appliance device has a number N=8 of row switching elements 10a. In the present instance the household appliance device has a number N=3 of column switching elements 12a. The household appliance device also has a number N×M=24 of heating matrix elements 16a. It is however conceivable for N and/or M to be any other natural number deemed particularly advantageous by a person skilled in the art. Alternatively or additionally a number N can be selected to be equal to a number M or such that the total number N+M is one greater than the number N×M.

An, in particular schematic circuit-type, arrangement of the electrical components of the household appliance device is described by way of example below with reference to i-th and j-th components of the household appliance device as well as those at position i,j. The following descriptions here also apply to further, equivalent electrical components.

The i-th row switching element 10a is configured as a transistor. The i-th row switching element 10a has a first connection. The first connection is a source connection. The first connection of the i-th row switching element 10a is connected to the heating matrix element 16a at position i,j. The i-th row switching element 10a has a second connection. The second connection is a drain connection. The second connection of the i-th row switching element 10a is connected to a reference potential 30a common to the row switching elements 10a. The reference potential 30a common to the row switching elements 10a is an operating potential of an operating voltage, preferably a ground potential. The household appliance device in particular has a rectifier, which converts a network voltage at least partially to the operating voltage. The operating voltage here is the voltage present between the reference potential 30a common to the row switching elements 10a and a further reference potential 32a common to the column switching elements 12a. The i-th row switching element 10a has a control connection. The control connection is a gate connection. The control connection is connected to a control unit 38a of the household appliance device.

The j-th column switching element 12a is configured as a transistor. The j-th column switching element 12a has a first connection. The first connection is a source connection. The first connection of the j-th column switching element 12a is connected to the further reference potential 32a common to the column switching elements 12a. The further reference potential 32a common to the column switching elements 12a is the further operating potential. The j-th column switching element 12a has a second connection. The second connection is a drain connection. The second connection of the j-th column switching element 12a is connected to the heating matrix element 16a at position i,j. The j-th column switching element 12a has a control connection. The control connection is a gate connection. The control connection is connected to the control unit 38a of the household appliance device.

The i-th row switching element 10a and the j-th column switching element 12a are arranged in a half bridge topology. It is conceivable for the household appliance device to comprise i-th further row switching elements 10a and j-th further column switching elements 12a, so the i-th row switching elements 10a, the i-th further row switching elements 10a, the j-th column switching elements 12a and the j-th further column switching elements 12a can be arranged in a full bridge topology.

The i-th row switching element 10a and the j-th column switching element 12a serve as inverter switching elements. The i-th row switching element 10a and the j-th column switching element 12a together form at least one inverter unit 54a at position i,j of the household appliance device. The household appliance device in particular comprises a number N×M of inverter units 54a. The control unit 38a is provided to activate the i-th row switching element 10a and the j-th column switching element 12a as inverter switching elements. The control unit 38a activates the i-th row switching element 10a and the j-th column switching element 12a in such a manner that a soft switching operation takes place between at least one first switching state and a second switching state of the i-th row switching element 10a and the j-th column switching element 12a.

The heating matrix element 16a at position i,j has at least one inductor 18a at position i,j. The inductor 18a at position i,j is connected to both the i-th row switching element 10a and the j-th column switching element 12a. The inductor 18a at position i,j has at least one connection 20a at position i,j. The connection 20a at position i,j is connected to both the i-th row switching element 10a, in particular the first connection of the i-th row switching element 10a, and the j-th column switching element 12a, in particular the second connection of the j-th column switching element 12a. A total N×M of inductors 18a are arranged in a schematic circuit in the heating matrix 14a.

The heating matrix element 16a at position i,j has at least one diode 24a at position i,j. The inductor 18a at position i,j is connected at least to the i-th row switching element 10a by means of the diode 24a at position i,j. A first connection of the diode 24a at position i,j is connected to the connection 20a at position i,j of the inductor 18a at position i,j. A second connection of the diode 24a at position i,j is connected to a first connection of the i-th row switching element 10a. The diode 24a at position i,j allows a current flow in the direction of the i-th row switching element 10a. The diode 24a at position i,j blocks a current flow in the direction of the inductor 18a at position i,j.

The heating matrix element 16a at position i,j has at least one further diode 26a at position i,j. The inductor 18a at position i,j is connected at least two the j-th column switching element 12a by means of the further diode 26a at position i,j. A first connection of the further diode 26a at position i,j is connected to the connection at position i,j of the inductor 18a at position i,j. A second connection of the further diode 26a at position i,j is connected to the second connection of the j-th column switching element 12a. The further diode 26a at position i,j allows a current flow in the direction of the inductor 18a at position i,j. The further diode 26a at position i,j blocks a current flow in the direction of the j-th column switching element 12a.

The heating matrix element 16a at position i,j has at least one capacitance 28a at position i,j. The capacitance 28a at position i,j is a capacitor. The inductor 18a at position i,j is connected at least to a reference potential 30a common to the heating matrix elements 16a by means of the capacitance 28a at position i,j. The reference potential 30a common to the heating matrix elements 16a is the operating potential. A first connection of the capacitance 28a at position i,j is connected to a further connection 42a at position i,j of the inductor 18a at position i,j. A second connection of the capacitance 28a at position i,j is connected to the common reference potential 30a.

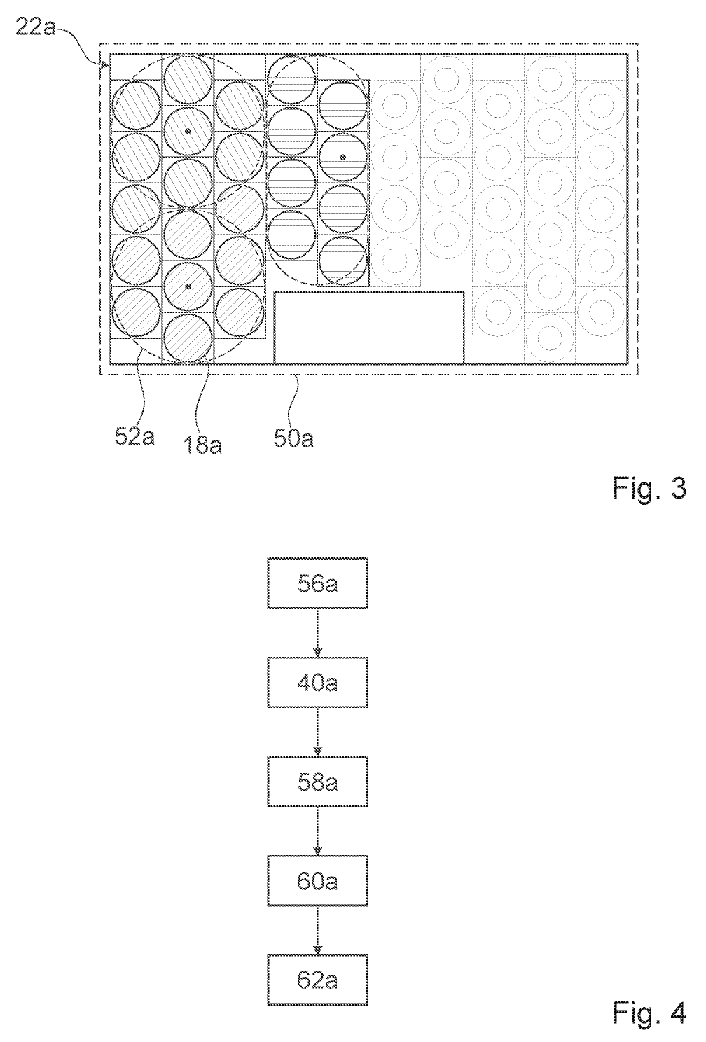

FIG. 3 shows a view from above of a part of the household appliance device with an inductor matrix 22a. In the present instance inductors 18a at position i,j of identical i are shown with identical hatching in FIG. 3. Inductors 18a for which i=j in the heating matrix 14a are also marked with a dot. The inductors 18a at position i,j are arranged spatially in the inductor matrix 22a. The inductor matrix 22a is different from the heating matrix 14a in respect of proximity relationships of at least two of the inductors 18a at position i,j relative to one another. In the inductor matrix 22a inductors 18a at position i,j of identical i or j are adjacent to one another. In the inductor matrix 22a the inductors 18a at position i,j are arranged spatially in such a manner that at least one inductor 18a at position i,j, for which i=j in the heating matrix 14a, is adjacent to at least one inductor 18a at position i,j, for which i≠j in the heating matrix 14a. An inductor 18a at position i,j, for which i=j in the heating matrix 14a, is surrounded, preferably surrounded in a circular manner, by multiple, in particular at least three, preferably at least four and particularly preferably at least five inductors 18a at position i,j, for which i≠j in the heating matrix 14a.

FIG. 4 shows a method for controlling the household appliance device. In the present instance the method is described with reference to exemplary operation of the electrical components with the indices i=1 and i=2 and the electrical components with the indices j=1 and j=2. The method can be applied in the same way to any further i-th electrical components and j-th electrical components.

The method comprises an operating step 56a. In the operating step 56a the control unit 38a activates the 2^{nd} row switching element 10a and the 1^{st} column switching element 12a as inverter switching elements. The 2^{nd} row switching element 10a and the 1^{st} column switching element 12a transition alternately through a switching operation from a first switching state to a second switching state. The 2^{nd} row switching element 10a and the 1^{st} column switching element 12a connect the heating matrix element 16a at position 2,1, in particular the inductor 18a at position 2,1, alternately to the reference potential 30a common to the row switching elements 10a and the further reference potential 32a common to the column switching elements 12a. The 2^{nd} row switching element 10a and the 1^{st} column switching element 12a generate a supply voltage, with which the heating matrix element 16a at position 2,1, in particular the inductor 18a at position 2,1, is operated. A heating current flows through the heating matrix element 16a at position 2,1, in particular the inductor 18a at position 2,1.

The method comprises a cookware detection mode 40a. The cookware detection mode 40a runs at the same time as the operating step 56a. Alternatively the cookware detection mode 40a can take place independently of the operating step 56a. The cookware detection mode 40a comprises a charging step 58a. In the charging step 58a the control unit 38a activates the 1^{st} column switching element 12a in such a manner that it transitions to a first switching state. The heating matrix element 16a at position 1,1, in particular the capacitance 28a at position 1,1, is charged by means of the 1^{st} column switching element 12a to the further reference potential 32a common to the column switching elements 12a. The control unit 38a activates the 1^{st} row switching element 10a in such a manner that it is in a second switching state and therefore does not establish a conducting connection to the reference potential 30a common to the row switching elements 10a. No current flows, with the result that the charged voltage is maintained. Similarly the heating matrix element 16a at position 2,2, in particular the capacitance 28a at position 2,2, is charged with the reference potential 30a common to the row switching elements 10a, which is made available by the 2^{nd} row switching element 10a. In the charging step 58a the control unit 38a activates the 2^{nd} row switching element 10a in such a manner that it transitions to a second switching state. The heating matrix element 16a at position 2,2, in particular the capacitance 28a at position 2,2, is charged to the reference potential 30a common to the row switching elements 10a. The control unit 38 activates the 2^{nd} column switching element 12a in such a manner that it is in the second switching state and therefore no conducting connection is established to the further reference potential 32a common to the column switching elements 12a. No current flows, with the result that the charged voltage is maintained.

The cookware detection mode 40a comprises a discharging step 60a. The discharging step 60a is performed during the operating step 56a. The operating voltage, which is present between the 2^{nd} row switching element 10a and the 1^{st} column switching element 12a, varies over time. The discharging step 60a is performed when the operating voltage has an at least essentially vanishingly low value. The control unit 38a discharges the heating matrix element 16a at position 1,1. To this end the control unit 38a switches the 1^{st} row switching element 10a to the first switching state. The 1^{st} row switching element 10a connects the heating matrix element 16a at position 1,1, in particular the capacitance 28a at position 1,1, to the reference potential 30a common to the row switching elements 10a. The heating matrix element 16a, in particular the capacitance 28a at position 1,1, discharges. A characteristic line 46a of the discharging operation is acquired. A further characteristic line 47a of the discharging operation is acquired.

The cookware detection mode 40a comprises a determination step 62a. In the determination step 62a a comparative characteristic line is tailored to the characteristic line 46a acquired in the discharging step 60a and in particular to the further characteristic line 47a. A quality of the electromagnetic coupling is determined from parameters of the comparative characteristic line. A degree of cover between the inductor 18a at position 1,1 and a cookware item coupled to the inductor 18a at position 1,1 and/or a material of the cookware item is/are also determined from the quality of the electromagnetic coupling.

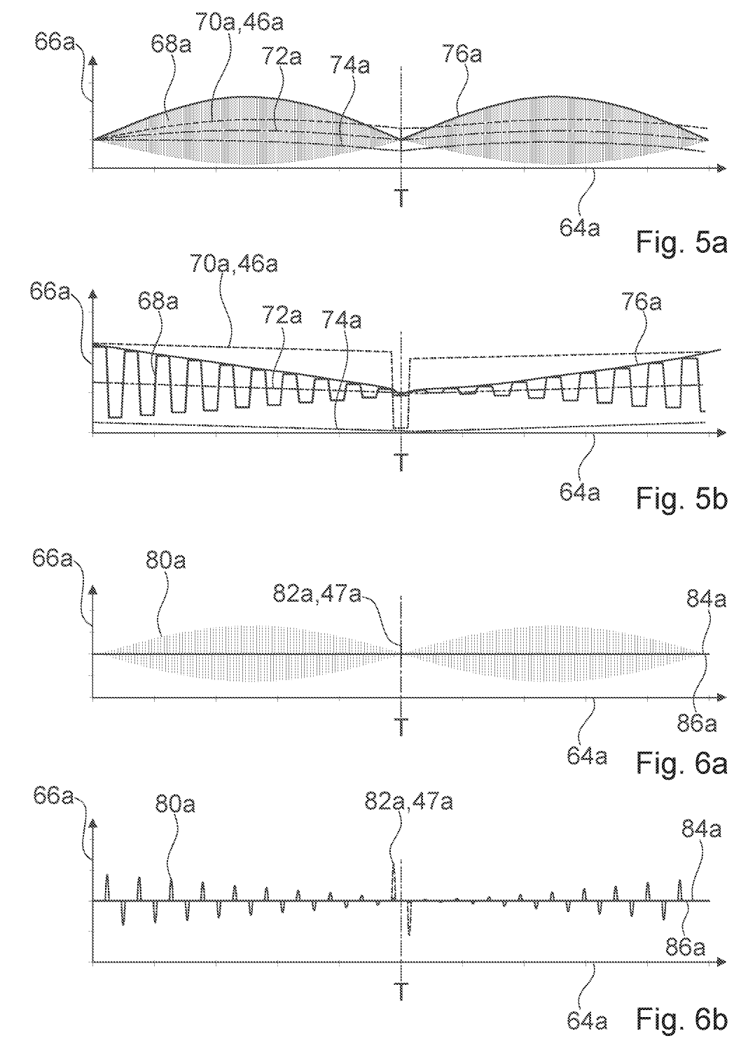

FIG. 5a shows a diagram of the method for controlling the household appliance device. A time is plotted on an x-axis 64a. A voltage is plotted on a y-axis 66a. A first voltage curve 68a shows a profile over time of the supply voltage present at the heating matrix element 16a at position 2,1. A second voltage curve 70a shows a profile over time of a voltage present at the heating matrix element 16a at position 1,1. A third voltage curve 72a shows a profile over time of a voltage present at the heating matrix element 16a at position 1,2. A fourth voltage curve 74a shows a profile over time of a voltage present at the heating matrix element 16a at position 2,2. A fifth voltage curve 76a shows a profile over time of the operating voltage. The curves 68a, 70a, 72a, 74a, 76a are shown again in FIG. 5b. FIG. 5b shows a region of the diagram in FIG. 5a about a time T, at which the operating voltage has an at least essentially vanishingly low value. In FIG. 5b the x-axis 64a has a finer scaling than in FIG. 5a.

FIG. 6a shows a diagram of the method for controlling the household appliance device. A time is plotted on an x-axis 64a. A current is plotted on a y-axis 66a. A first current curve 80a shows a profile over time of the heating current flowing through the heating matrix element 16a at position 2,1. A second current curve 82a shows a profile over time of a current flowing through the heating matrix element 16a at position 1,1. A third current curve 84a shows a current flowing through the heating matrix element 16a at position 1,2. A fourth current curve 86a shows a current flowing through the heating matrix element 16a at position 2,2. FIG. 6b shows a region of the diagram in FIG. 6a about a time T, at which the operating voltage has an at least essentially vanishingly low value. In FIG. 6b the x-axis 64 has a finer scaling than in FIG. 6a.

The second current curve 82a and the second voltage curve 70a show the charging step 58a of the heating matrix element 16a at position 1,1. In the charging step 58a the heating matrix element 16a at position 1,1 is charged with the further reference potential 32a common to the column switching elements 12a. In the discharging step 60a, as soon as the operating voltage, as in the fifth voltage curve 76a, has an at least essentially vanishing value, the heating matrix element 16a at position 1,1 is discharged. A current flows, corresponding to the second current curve 82a. The second voltage curve 70a is acquired. The second characteristic voltage line serves as a characteristic line 46a for determining the electrical characteristic variable. The second current curve 82a is acquired. The second current curve 82a serves as a further characteristic line 47a for determining the electrical characteristic variable.

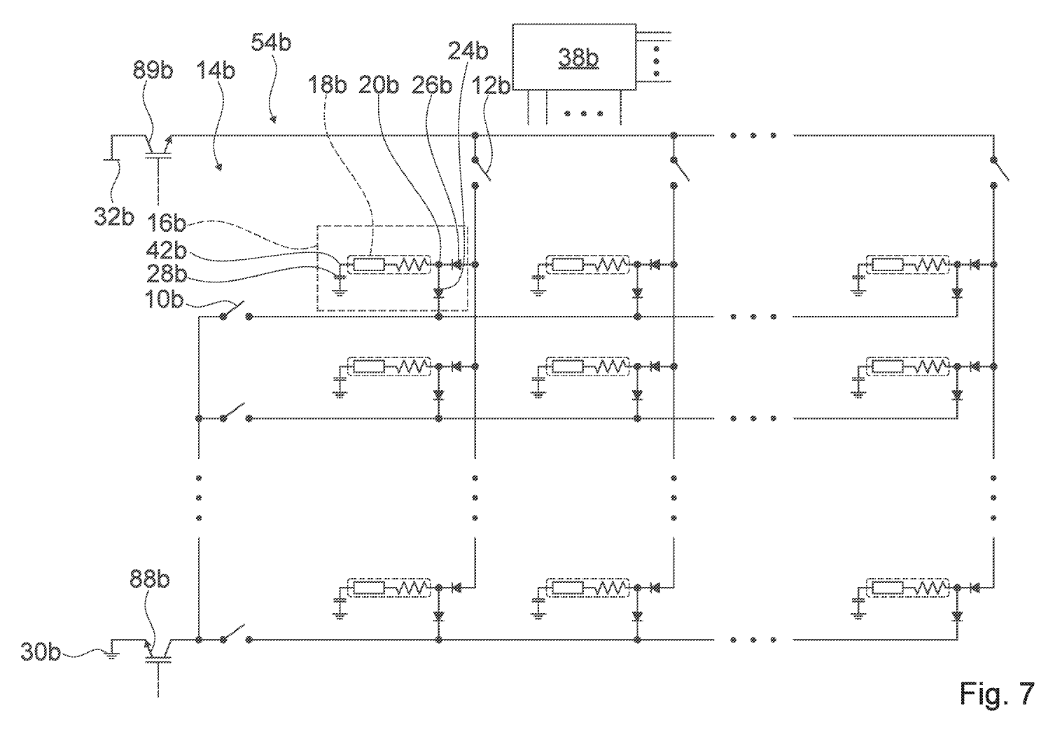

FIGS. 7 to 16 show further exemplary embodiments of the invention. The description that follows and the drawings are essentially restricted to the differences between the exemplary embodiments, it being possible to refer, in respect of identically marked components, in particular components with identical reference characters, in principle also to the drawing and/or description of the other exemplary embodiments, in particular in FIGS. 1 to 6. To distinguish between the exemplary embodiments the letter a is used after the reference characters of the exemplary embodiments in FIGS. 1 to 6. The letter a is replaced by the letters b to h, k, p and q in the exemplary embodiments in FIGS. 7 to 16.

FIG. 7 shows a circuit diagram of a further exemplary embodiment of the invention. The further exemplary embodiment differs from the previous exemplary embodiment at least essentially in respect of a number N and a number M. In the present instance a number N of row switching elements 10b is equal to the number M of column switching elements 12b. The total number N+M of row switching elements 10b and column switching elements 12b is also smaller than or equal to the number N×M of heating matrix elements 16b. In the present instance the number N=4 and the number M=4. In the present instance at least the i-th row switching element 10b, in particular all the row switching elements 10b, and/or at least the j-th column switching element 12b, in particular all the column switching elements 12b, is/are configured as switches, preferably relays. The household appliance device also has an additional inverter unit 54b. The inverter unit 54b has a first inverter element 88b. The inverter unit 54b also has a second inverter element 89b. The inverter elements 88b, 89b are configured as transistors. The inverter element 88b connects the row switching elements 10b to a reference potential 30b common to the row switching elements 10b. The further inverter element 89b connects the column switching elements 12b to a further reference potential 32b common to the column switching elements 12b.

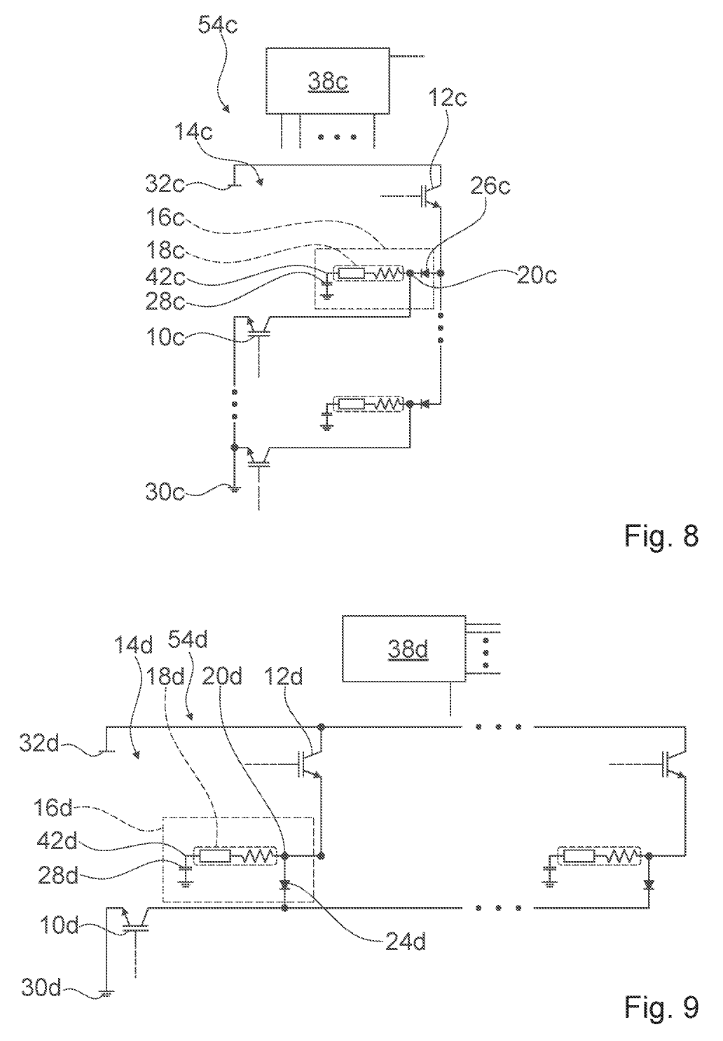

FIG. 8 shows a circuit diagram of a further exemplary embodiment of the invention. The further exemplary embodiment differs from the previous exemplary embodiment at least essentially in respect of a number N and M. A total number N+M of row switching elements 10c and column switching elements 12c is one greater than a number N×M of heating matrix elements 16c. In the present instance the number N=2 and the number M=1. A heating matrix 14c forms a schematic circuit vector, in particular a column vector. In a configuration, in which the total number N+M is one greater than the number N, diodes at position i,1 can be dispensed with. A first connection of the i-th row switching element 10c is connected to a connection 20c at position i,1 of an inductor 18c at position i,1.

FIG. 9 shows a circuit diagram of a further exemplary embodiment of the invention. The further exemplary embodiment differs from the previous exemplary embodiment at least essentially in respect of a number N and M. A total number N+M of row switching elements 10d and column switching elements 12d is one greater than a number N×M of heating matrix elements 16d. In the present instance the number N=1 and the number M=2. A heating matrix 14d forms a schematic circuit vector, in particular a row vector. In a configuration, in which the total number N+M is one greater than the number N, diodes at position i,j can be dispensed with. A first connection of the j-th row switching element 12d is connected to a connection 20d at position 1,j of an inductor 18d at position 1,j.

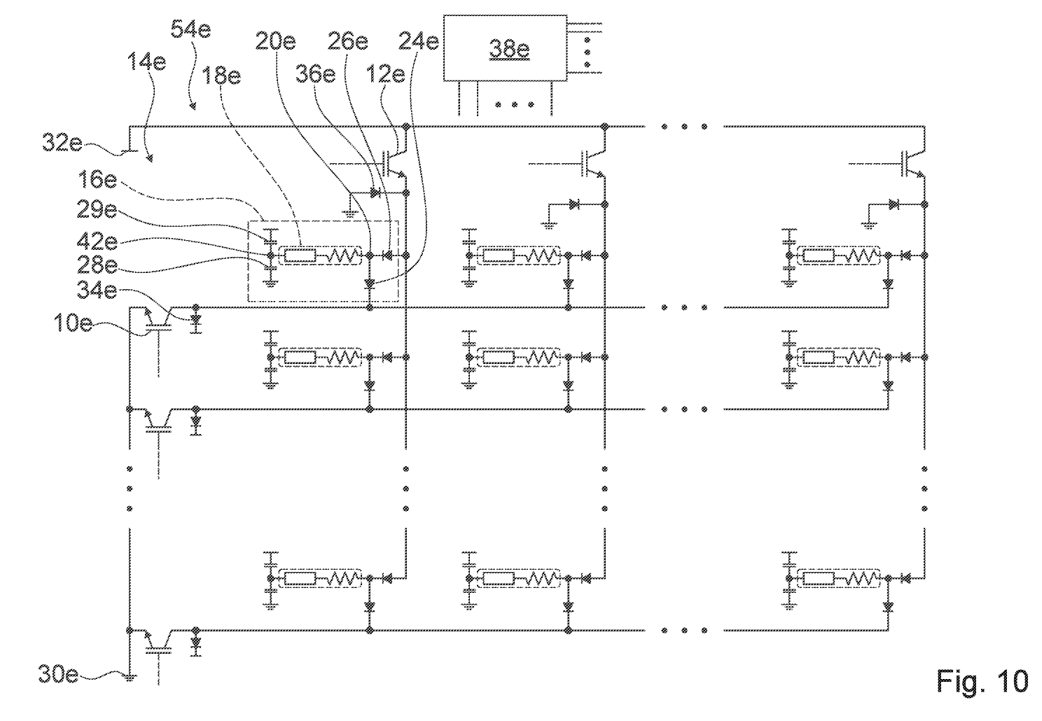

FIG. 10 shows a further exemplary embodiment of the invention. The further exemplary embodiment differs from the previous exemplary embodiment at least essentially in respect of further electrical components of the household appliance device. The household appliance device has a number M of column diodes 36e. The j-th column diode 36e connects at least one j-th column switching element 12e to at least one reference potential 30e common to the column switching elements 12e. The reference potential 30e common to the column switching elements 12e is equal to a reference potential 30e common to the row switching elements 10e. A first connection of the j-th column switching element 12e is connected to a further reference potential 32e common to the column switching elements 12e. A second connection of the j-th column switching element 12e is connected to a first connection of a j-th column diode 36e. The j-th column diode 36e blocks a current in the direction of the reference potential 30e common to the column switching elements 12e. The j-th column diode 36e allows a current from the direction of the reference potential 30e common to the column switching elements 12e.

The household appliance device has a number N of row diodes 34e. The i-th row diode 34e connects at least one i-th row switching element 10e to at least one further reference potential 32e common to the row switching elements 10e. The further reference potential 32e common to the row switching elements 10e is a further operating voltage. The further reference potential 32e common to the row switching elements 10e is equal to the further reference potential 32e common to the column switching elements 12e. A first connection of the i-th row diode 34e is connected to a first connection of the i-th row switching element 10e. A second connection of the i-th row diode 34e is connected to the further reference potential 32e common to the row switching elements 10e. The i-th row diode 34e blocks a current from the direction of the further reference potential 32e common to the row switching elements 10e. The i-th row diode 34e allows a current from the direction of the further reference potential 32e common to the row switching elements 10e.

A heating matrix element 16e at position i,j has at least one further capacitance 29e at position i,j. The further capacitance 29e at position i,j is a capacitor. An inductor 18e at position i,j is connected at least to a further reference potential 32e common to the heating matrix elements 16e by means of the further capacitance 29e at position i,j. The further reference potential 32e common to the heating matrix elements 16e is a further operating voltage. A first connection of the further capacitance 28e at position i,j is connected to a further connection 42e at position i,j of the inductor 18e at position i,j. A second connection of the capacitance 28e at position i,j is connected to the further reference potential 32e common to the heating matrix elements 16a. Alternatively or additionally the capacitance 28e at position i,j can be configured as a capacitor network, which comprises multiple capacitors connected in series and/or in a parallel manner.

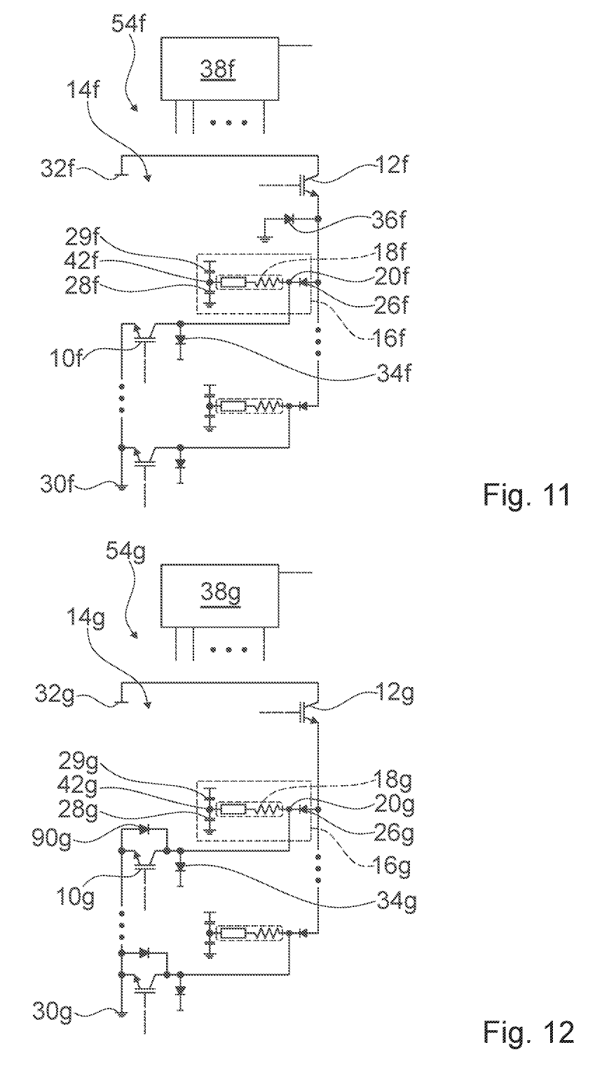

FIG. 11 shows a further exemplary embodiment of the invention. The further exemplary embodiment differs from the previous exemplary embodiment at least essentially in respect of a number N and a number M. The total number N+M of row switching elements 10f and column switching elements 12f is one greater than the number N×M of heating matrix elements 16f. In the present instance the number N=2 and the number M=1. The heating matrix 14f forms a schematic circuit vector, in particular a column vector. In a configuration, in which the total number N+M is one greater than the number N, diodes at position i,1 can be dispensed with.

FIG. 12 shows a further exemplary embodiment of the invention. The further exemplary embodiment differs from the previous exemplary embodiment at least essentially in respect of a number N and a number M. The total number N+M of row switching elements 10 g and column switching elements 12g is one greater than the number N×M of heating matrix elements 16g. In the present instance the number N=2 and the number M=1. The heating matrix 14g forms a schematic circuit vector, in particular a column vector. In a configuration, in which the total number N+M is one greater than the number N, diodes at position i,1 can be dispensed with. The household appliance device has a number N of backflow diodes 90g. The i-th backflow diode 90g is connected to the i-th row switching element 10g. The i-th backflow diode 90g is connected parallel to the i-th row switching element 10g. A first connection of the backflow diode 90g is connected to a first connection of the i-th row switching element 10g. A second connection of the i-th backflow diode 90g is connected to a second connection of the i-th row switching element 10g. The i-th backflow diode 90g blocks a current flow in the direction of the reference potential 30g common to the row switching elements 10g. The i-th backflow diode 90g allows a current flow from the direction of the reference potential 30g common to the row switching elements 10g. Alternatively or additionally the household appliance device can have a number of further backflow diodes 90g. A j-th further backflow diode 90g could be connected parallel to a j-th column switching element 12g. A column diode can also be dispensed with in the present instance.

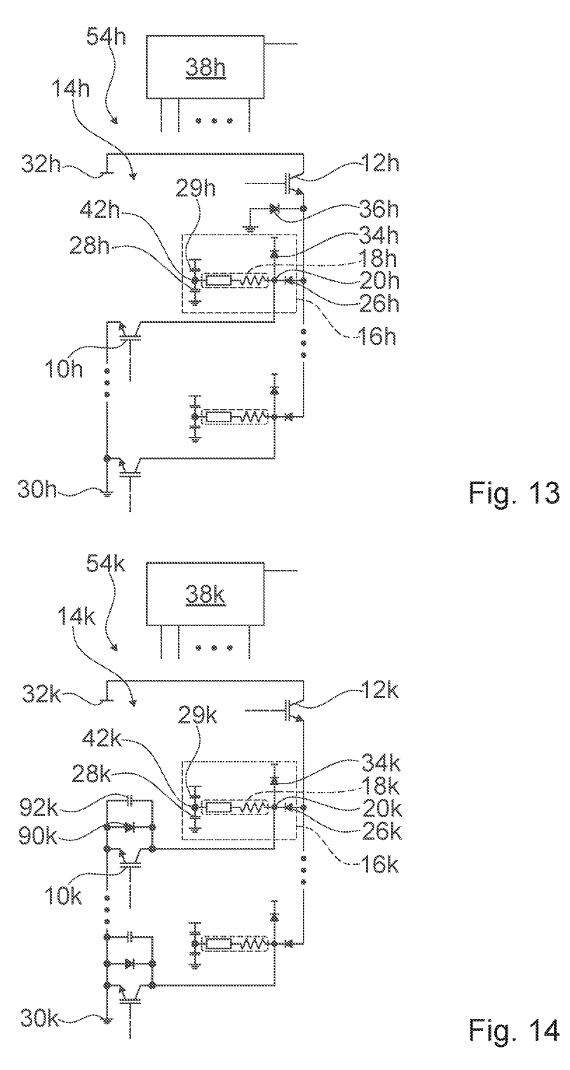

FIG. 13 shows a further exemplary embodiment of the invention. The further exemplary embodiment differs from the previous exemplary embodiment at least essentially in respect of a number of additional electrical components. The present exemplary embodiment differs by way of a circuit of row diodes 34h. In the present instance the i-th row diode 34h is connected to a connection 20h at position i,j of an inductor 18h at position i,j. A first connection of the i-th row diode 34h is connected to the connection 20h at position i,j. A second connection of the i-th row diode 34h is connected to a further reference potential 32h common to the row switching elements 10h. The i-th row diode 34h blocks a current from the direction of the further reference potential 32h common to the row switching elements 10h. The i-th row diode 34h allows the passage of a current from the direction of the further reference potential 32h common to the row switching elements 10h.

FIG. 14 shows a further exemplary embodiment of the invention. The further exemplary embodiment differs from the previous exemplary embodiment at least essentially in respect of a number of additional electrical components. The household appliance device has a number N of row capacitances 92k. The i-th row capacitance 92k is connected parallel to an i-th row switching element 10k. The i-th row capacitance 92k is also connected parallel to an i-th backflow diode 90k. A first connection of the i-th row capacitance 92k is connected to a first connection of the i-th row switching element 10k. A second connection of the i-th row capacitance 92k is connected to a second connection of the i-th row switching element 10k. A column diode can also be dispensed with in the present instance.

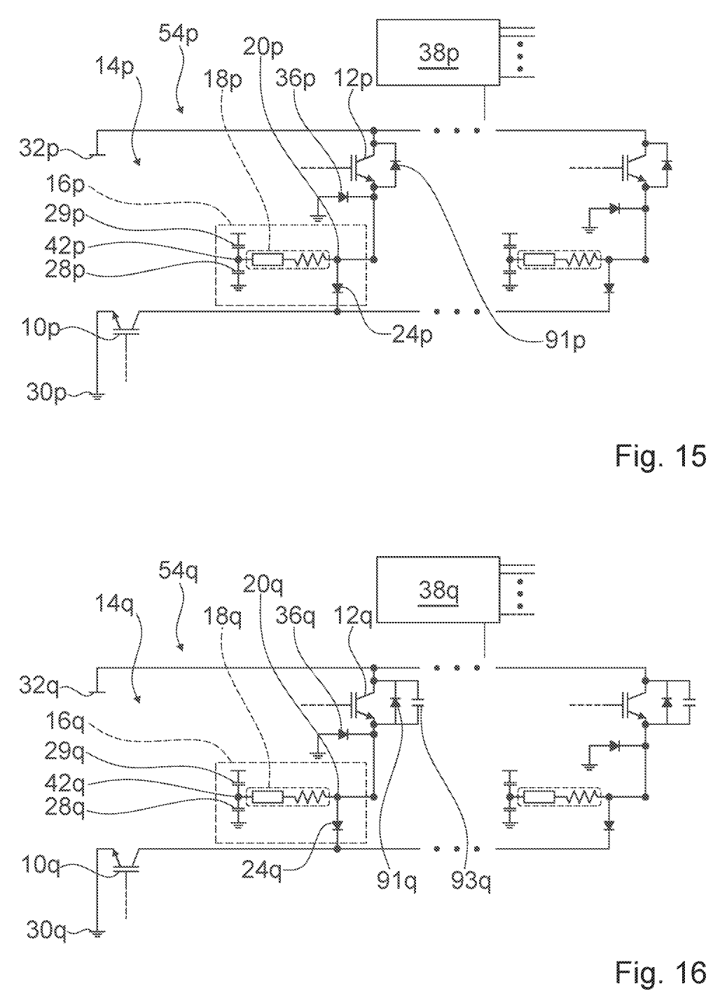

FIG. 15 shows a further exemplary embodiment of the invention. The further exemplary embodiment differs from the previous exemplary embodiment at least essentially in respect of a number N and a number M. The total number N+M of row switching elements 10p and column switching elements 12p is one greater than the number N×M of heating matrix elements 16p. In the present instance the number N=1 and the number M=2. The heating matrix 14p forms a schematic circuit vector, in particular a row vector. In a configuration, in which the total number N+M is one greater than the number N, further diodes at position j,1 can be dispensed with. The household appliance device has a number M of further backflow diodes 91p. The j-th further backflow diode 91p is connected to the j-th column switching element 12p. The j-th further backflow diode 91p is connected parallel to the j-th column switching element 12p. A first connection of the further backflow diode 91p is connected to a first connection of the j-th column switching element 12p. A second connection of the j-th further backflow diode 91p is connected to a second connection of the j-th column switching element 12p. The j-th further backflow diode 91p allows a current flow in the direction of the reference potential 32p common to the column switching elements 12p. The j-th further backflow diode 91p blocks a current flow from the direction of the reference potential 32 common to the column switching elements 12p. Alternatively or additionally the household appliance device can have a number of backflow diodes 90p. An i-th backflow diode 90p could be connected parallel to an i-th row switching element 10p. A row diode can also be dispensed with in the present instance. An i-th row diode can also be dispensed with.

FIG. 16 shows a further exemplary embodiment of the invention. The further exemplary embodiment differs from the previous exemplary embodiment at least essentially in respect of a number of additional electrical components. The household appliance device has a number M of column capacitances 93q. The j-th column capacitance 93q is connected parallel to a j-th column switching element 12q. The j-th column capacitance 93q is connected parallel to a j-th further backflow diode 91q. A first connection of the j-th column capacitances 93q is connected to a first connection of the j-th column switching element 12q. A second connection of the j-th column capacitances 93q is connected to a second connection of the j-th column switching element 12q. An i-th row diode can also be dispensed with.

### REFERENCE CHARACTERS

10 Row switching element
12 Column switching element
14 Heating matrix
16 Heating matrix element
18 Inductor
20 Connection
22 Inductor matrix
24 Diode
26 Further diode
28 Capacitance
29 Capacitance
30 Reference potential
32 Further reference potential
34 Row diode
36 Column diode
38 Control unit
40 Cookware detection mode
42 Further connection
46 Characteristic line
47 Characteristic line
48 Household appliance
50 Cooktop plate
52 Heating zone position
54 Inverter unit
56 Operating step
58 Charging step
60 Discharging step
62 Determination step
64 X-axis
66 Y-axis
68 First voltage curve
70 Second voltage curve
72 Third voltage curve
74 Fourth voltage curve
76 Fifth voltage curve
80 First current curve
82 Second current curve
84 Third current curve
86 Fourth current curve
88 Inverter element
89 Inverter element
90 Backflow diode
91 Further backflow diode
92 Row capacitance
93 Column capacitances
T Time

1-18. (canceled)

19. A household appliance device, comprising:
an integer number N of row switching elements at a row position i, wherein i is an integer number 1≤i≤N,
an integer number M of column switching elements at a column position j, wherein j is an integer number 1≤j≤M, and
a heating matrix comprising at least N×M heating matrix elements having positions (i, j), with N+M>2, wherein a heating matrix element at the position (i,j) comprises at least one inductor at the position (i,j) and is connected to both the i-th row switching element and the j-th column switching element.

20. The household appliance device of claim 19, constructed in the form of a cooking appliance device.

21. The household appliance device of claim 19, wherein the at least inductor at the position (i,j) has at least one terminal at the position (i,j) which is connected to both the i-th row switching element and the j-th column switching element.

22. The household appliance device of claim 19, wherein a plurality of inductors are spatially arranged in an inductor matrix having a proximity relationship between at least two of the inductors relative to one another that is different from an arrangement of the inductors in a schematic circuit diagram of the heating matrix.

23. The household appliance device of claim 22, wherein the plurality of inductors are spatially arranged in the inductor matrix such that at least one inductor at the position (i,j), for which i=j in the heating matrix, is adjacent to at least one inductor at the position (i,j), for which i≠j in the heating matrix.

24. The household appliance device of claim 22, wherein the inductors of the inductor matrix at positions (i,j) having identical i or identical j are located adjacent to one another.

25. The household appliance device of claim 19, wherein the number N of row switching elements is equal to the number M of column switching elements.

26. The household appliance device of claim 19, wherein a total number N+M of row switching elements and column switching elements is greater by one than a number N×M of heating matrix elements.

27. The household appliance device of claim 19, wherein the heating matrix element at the position (i,j) comprises at least one diode at the position (i,j), which connects a respective inductor at position (i,j) at least to the i-th row switching element.

28. The household appliance device of claim 19, wherein the heating matrix element at the position (i,j) comprises at least one further diode connecting the inductor at the position (i,j) at least to the j-th column switching element.

29. The household appliance device of claim 19, wherein the heating matrix element at the position (i,j) comprises at least one capacitance at the position (i,j) connecting the inductor at the position (i,j) at least to at least one reference potential that is common to the heating matrix elements.

30. The household appliance device of claim 19, further comprising a number M of column diodes at the column position j, with the j-th column diode connecting at least the j-th column switching element to at least one reference potential that is common to the column switching elements.

31. The household appliance device of claim 30, further comprising a number N of row diodes at the row position i, with the i-th row diode connecting at least the i-th row switching element to at least one further reference potential common to the row switching elements.

32. The household appliance device of claim 30, further comprising a control unit configured to control the row switching elements and the column switching elements.

33. The household appliance device of claim 32, wherein the control unit is configured to control the row switching elements and the column switching elements as inverter switching elements.

34. The household appliance device of claim 32, wherein the control unit is configured to determine, in at least one cookware detection mode, at least one electrical characteristic variable occurring on at least one of the inductors, when an operating voltage assumes an almost negligible low value.

35. The household appliance device as claimed in claim 34, wherein the control unit is configured to, in the cookware detection mode, to first charge the inductor and thereafter discharge the inductor again, when the operating voltage assumes an almost negligible low value.

36. The household appliance device of claim 35, wherein the control unit is configured to measure, in the cookware detection mode, a characteristic curve of a discharging operation of the inductor and to determine the electrical characteristic variable form the characteristic curve.

37. A household appliance, comprising a household appliance device which includes
an integer number N of row switching elements at a row position i, wherein i is an integer number 1≤i≤N,
an integer number M of column switching elements at a column position j, wherein j is an integer number 1≤i≤M, and
a heating matrix comprising at least N×M heating matrix elements having positions (i, j), with N+M>2, wherein a heating matrix element at the position (i,j) comprises at least one inductor at the position (i,j) and is connected to both the i-th row switching element and the j-th column switching element.

38. The household appliance of claim 37, wherein the household appliance device is constructed in the form of a a cooking appliance.
